(19) United States
(12) Patent Application Publication
(10) Pub. No.: US 2001/0026815 A1
(43) Pub. Date: Oct. 4, 2001

(54) Used in manufacturing nonwoven fabric

(76) Inventor: Mitsuru Suetomi, Hyogo (JP)

Correspondence Address: WENDEROTH, LIND & PONACK, L.L.P., 2033 K STREET N. W., SUITE 800, WASHINGTON, DC, 20006-1021, US

(21) Appl. No.: 09/846,199

(22) Filed: May 2, 2001

(30) Foreign Application Priority Data
May 27, 1999 (JP) 11-147627

(51) Int. Cl. B29C 67/02

(52) U.S. Cl. 425/7; 425/72.2

(57) ABSTRACT

A spinning die for nonwoven fabric is provided which can spin fibers having fine diameters and can reduce the energy cost. A pair of hot air discharge slits are provided near the tips of nozzles for extruding a molten polymer, and a pair of cool air discharge slits are provided downstream to supply cool air in a large amount, thereby orientating molten polymer extruded from the nozzles by the negative pressure produced by current of cool air.

### BACKGROUND OF THE INVENTION

This invention relates to a spinning die used in manufacturing a nonwoven fabric by a melt-blow method.

As schematically shown in FIG. 4, in a melt-blow method, raw material chips put in a hopper 1 is heated and melted in an extruder 2, and supplied into a die 3 for spinning. The spun short fibers are deposited into a sheet on a conveyor 4 comprising a collecting net, and after the sheet has been passed through calender rolls 5 while peeling it off the conveyor 4, it is taken up by a take-up device 6.

The die 3 serves to spin a molten resin discharged through a spinning port 3a with hot air discharged through a hot air discharge port 3b. Since a delicate balance is required between the amount of molten polymer discharged through the spinning port 3a and the discharge amount of hot air, it was difficult to spin fibers having a desired diameter, in particular fibers having a fine diameter, and to obtain a nonwoven fabric having high bulkiness and good drape. Further, since it is necessary to supply a large amount of hot air, energy cost was high.

An object of this invention is to provide a melt-blow type spinning die for nonwoven fabric which can spin fibers having a fine diameter and can reduce the energy cost.

### SUMMARY OF THE INVENTION

According to this invention, there is provided a spinning die used in manufacturing nonwoven fabric by melt-blow method wherein a pair of hot air discharge slits are provided opposite to each other near the tips of nozzles for extruding a molten polymer with the nozzles disposed therebetween, a pair of cool air discharge slits are provided downstream thereof, opposite to each other, with the nozzles disposed therebetween, and the amount of cool air discharged from the cool air discharge slits is greater than the amount of hot air discharged from the hot air discharge slits.

Other features and objects of the present invention will become apparent from the following description made with reference to the accompanying drawings, in which:

### BRIEF DESCRIPTION OF THE DRAWINGS

FIG. 1 is a cross-sectional view of a spinning pack having a spinning die of this invention;

FIG. 2 is an enlarged sectional view of the spinning die;

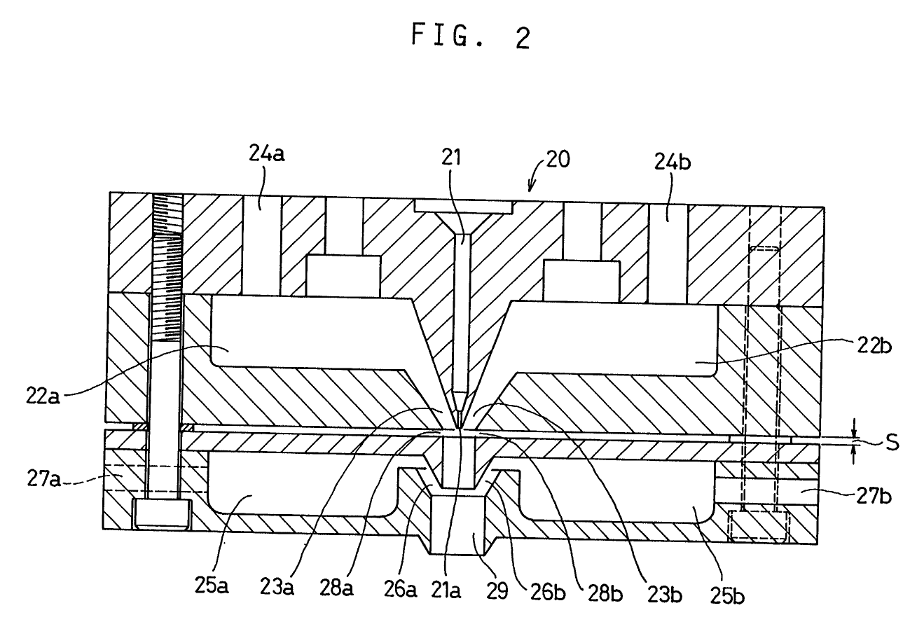

FIG. 3 is a perspective view of the same; and

FIG. 4 is a partially cross-sectional schematic view showing a method of manufacturing a nonwoven fabric by a conventional melt-blow method.

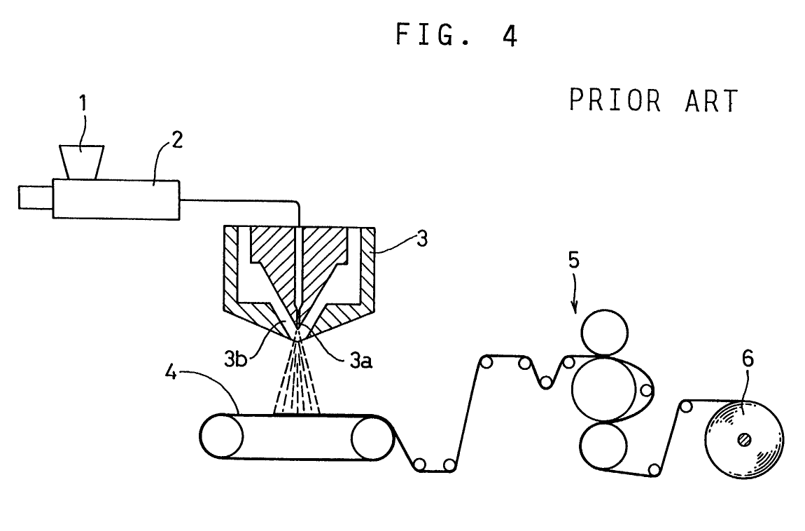

### DETAILED DESCRIPTION OF THE PREFERRED EMBODIMENT

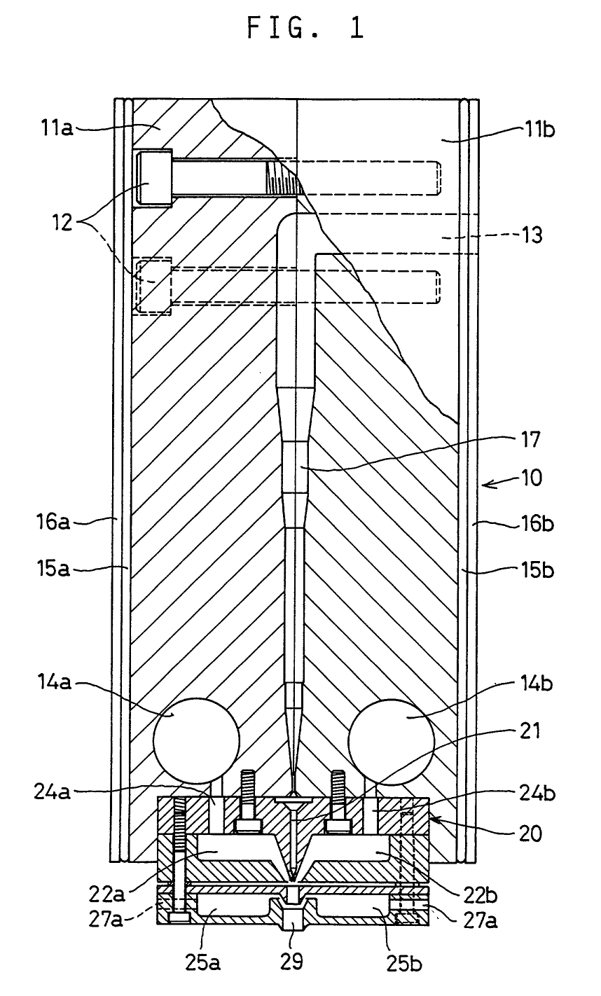

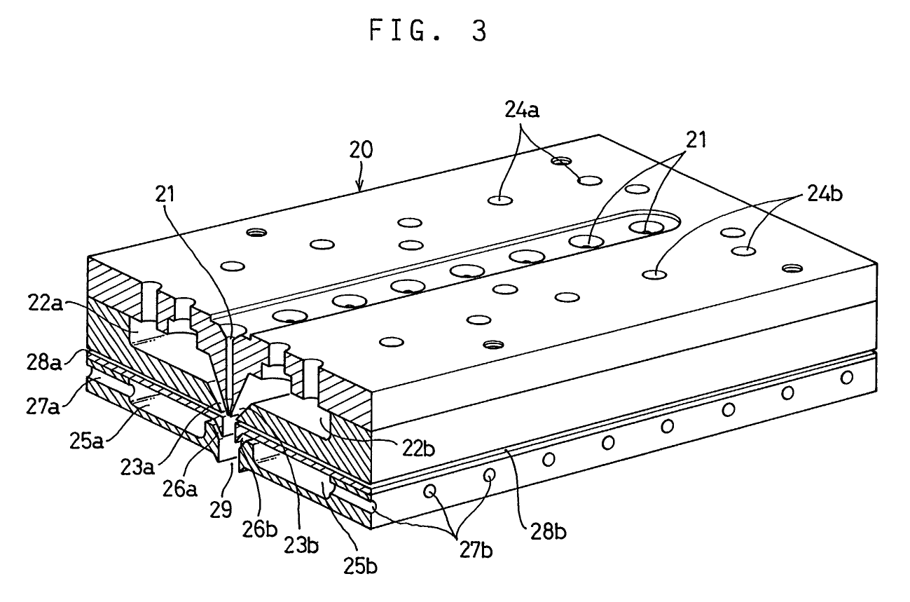

Hereinbelow, the embodiment of this invention is described with reference to FIGS. 1 and 3. As shown, a spinning die 20 is mounted to the bottom end of a spinning pack 10 in which bodies 11a and lib split in two are joined together by bolts 12. At upper portions of the bodies 11a, 11b, an injection port 13 is provided to supply a molten polymer such as a polypropylene resin, polyester resin, nylon (trademark). At their lower portions, hot air supply ports 14a, 14b are provided. Panel heaters 15a and 15b are kept in abutment with the side faces of the bodies by press plates 16a, 16b.

In the spinning die 20, a plurality of nozzles 21 are arranged in a row at the tip of a polymer passage 17 in communication with the polymer injection port 13. The tips of the nozzles 21 are disposed between an opposed pair of discharge slits 23a and 23b for discharging hot air from hot air chambers 22a and 22b, which communicate with the hot air supply ports 14a and 14b through passages 24a and 24b, respectively. At a regular distance S from the hot air discharge slits 23a and 23b, cool air chambers 25a and 25b and a pair of cool air discharge slits 26a and 26b are arranged opposite to each other with the nozzles 21 disposed therebetween. The cool air chambers 25a and 25b communicate with cool air supply ports 27a and 27b, respectively. The front portions of the cool air discharge slits 26a and 26b are formed into a spinning port 29. The distance S defines suction slits 28a and 28b for outer air (accompanying flow) near the tip of the nozzles 21. The distance S is preferably 2-10 mm.

When molten polymer is extruded through the nozzles 21, it is pulled out as if it is sandwiched by hot air blown from both sides through the pair of hot air discharge slits 23a, 23b, which are inclined in its extruding direction, and cool air is discharged in a large amount through the cool air discharge slits 26a, 26b. Thus the molten polymer extruded from the nozzles 21 is sharply sucked and orientated under a negative pressure, and crystallization progresses at the same time. At this time, the temperature of hot air is preferably about 200-300° C., that of cool air is preferably about 10-30° C., and the amount of hot air is preferably about 5-20% of cool air. For example, if cool air is 100-250 m/second, hot air is about 5-50 m/second.

That is to say, it will be enough if hot air can heat the molten polymer extruded from the nozzles 21 to such an extent that it will not cool sharply to form fibers having a fine diameter and good drape by sharply orienting it by a negative pressure produced by cool air. Also by forming the slits 28a, 28b for producing accompanying flow, it is possible to save the air amount. Like the hot air discharge slits 23a, 23b, the cool air discharge slits 26a, 26b also should preferably have an inclination sloping downwardly toward the spinning port 29.

According to this invention, since molten polymer extruded by the nozzles is heated by hot air in such a small amount as not to cool is orientated under negative pressure by a large amount of cool air and is sharply cooled, the orientation magnification increases, so that fibers which are of fine diameter and in which crystallization has progressed can be obtained. Also a nonwoven fabric having high bulkiness, high tenacity, and good drape can be obtained.

Since hot air is used only in a small amount, the energy consumption is small, so that it is possible to increase the amount of discharged polymer than before. This increases productivity.

Besides, by controlling the discharge amount of cool air, the diameter of spun fibers can be adjusted.

What is claimed is:

1. A spinning die used in manufacturing nonwoven fabric by melt-blow method wherein a pair of hot air discharge slits are provided opposite to each other near the tips of nozzles for extruding a molten polymer with said nozzles disposed therebetween, a pair of cool air discharge slits are provided downstream thereof, opposite to each other, with said nozzles disposed therebetween, and the amount of cool air discharged from said cool air discharge slits is greater than the amount of hot air discharged from said hot air discharge slits.

2. The spinning die as claimed in claim 1 wherein between said hot air discharge slits and said cool air discharge slits, a pair of slits communicating with the outer air are provided opposite to each other with said nozzles disposed therebetween.
